(19) United States
(12) Patent Application Publication
(10) Pub. No.: US 2005/0177538 A1
(43) Pub. Date: Aug. 11, 2005

(54) Preference information managing apparatus which stores users' usage history of packaged contents, calculates scores of the usage history and outputs the result of the calculation as a preference information, and preference information managing apparatus which stores users' usage history of packaged contents and the other contents, and calculates scores of the usage history in such a manner that a usage history of packaged contents is considered to be more valuable than a usuage history of other contents, and outputs the result of the calculation as a preference information

(76) Inventors: Yusuke Shimizu, Sherman Oaks, CA (US); Masayuki Kozuka, Arcadia, CA (US); Shunji Harada, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/767,171

(22) Filed: Jan. 30, 2004

(51) Int. Cl. G06F 7/00

(52) U.S. Cl. 707/1

(57) ABSTRACT

A preference information managing apparatus which outputs preference information reflecting a user's preference by (i) storing characteristics information which represents characteristics of a content relating to the user's usage and (ii) calculating a score of each piece of characteristics information, comprising: an obtaining unit operable to obtain characteristics information corresponding to a packaged content used by the user; a storing unit operable to store characteristics information obtained by the obtaining unit; and a calculating unit operable to (i)calculate a score of each piece of characteristics information stored in the storing unit, and (ii) output a piece of characteristics information whose score is high, as preference information.

### BACKGROUND OF THE INVENTION

(1) Field of the Invention

The present invention relates to a preference information managing apparatus which outputs preference information reflecting preference of a user for purposes including automatic recording of contents, and more specifically relates to the art of outputting more accurate preference information than that of conventional art.

(2) Description of the Related Art

In recent years, with the trend towards digitization of audio-video equipment and increase in capacity of storage media, automatic recording apparatuses have been put to practical use. The automatic recording apparatuses automatically record contents which the user is likely to prefer, based on preference information reflecting preference of the user. Currently, such automatic recording apparatuses mainly have three methods for automatic recoding.

(a) A method where an automatic recording apparatus (i) accepts arbitrary keywords, genres or the like directly from a user as preference information, (ii) automatically searches, from Electric Program Guide, for contents including accepted keywords, contents of the accepted genres, etc., and (iii) records the searched contents as contents matching the preference information.

(b) A method where an automatic recorder (i) automatically stores and counts keywords, genres or the like relating to the programs which the user actually watched, (ii) considers high-frequency keywords, contents of high-frequency genres, etc. as preference information, (iii) searches, from Electric Program Guide, for contents including the high-frequency keywords and contents of the high-frequency genres, etc., and (iv) automatically records the searched contents as contents matching with the preference information.

(c) A method where an external server (i)automatically stores and counts keywords, genres or the like relating to the contents which the user accessed via a network, (ii) considers high-frequency keywords and contents of high-frequency genres, etc. as preference information, and (iii) selects and unilaterally transmits, to the user's apparatus, the contents including the high-frequency keywords and the contents of the high-frequency genres, etc. as contents matching the preference information, and the user's apparatus records, without selection, the contents transmitted by the external server.

However, the following problems occur with the automatic recording method described above.

In the case of the method (a), users themselves have to input their preference information, which means users have to spend time for the operation. Also, if users do not input sufficient preference information, an automatic recording function possibly does not work effectively.

Furthermore, many users of the automatic recording apparatus are supposed to consider that the operations for timer recording are troublesome, and those users are very likely to consider that the operations for inputting their preference information are troublesome as well. Therefore, it is especially a problem to compel those users to input their preference information themselves.

In the case of (b) and (c), the preference information included in one apparatus is possibly different from the preference information included in another apparatus because pieces of the information are separately stored and calculated by each method for obtaining contents. Also, it takes the recording apparatus a certain amount of time to store sufficient information and to obtain accurate and dependable preference information.

Meanwhile, users can obtain contents from various sources, such as purchased discs, disc rental, VOD (Video on Demand), cable TV, commercial satellite broadcasting, and ground-based broadcasting. The period of time when the contents are obtainable and the value of the contents depend on the sources.

If all the information obtained from these various sources is counted by the gross, it is expected that the difference of the preference information among apparatuses is resolved, and the period for storing sufficient information is shorten. However, because the period of time when the contents are obtainable and the value of the contents depend on the sources as described above, it is supposed that accurate and dependable preference information cannot be obtained by a simple counting. It is also supposed that packaged contents, which users can obtain only from purchased discs or disc rental, are more highly rated and more preferred by users than the contents from other sources.

### SUMMARY OF THE INVENTION

The object of the present invention is therefore to provide a preference information managing apparatus and a preference information managing method, which can digitalize and calculate users' preference effectively and output more accurate preference information.

To fulfill the above object, the preference information managing apparatus of the present invention is a preference information managing apparatus which outputs preference information reflecting a user's preference, comprising: an obtaining unit operable to obtain one or more pieces of characteristics information corresponding to a packaged content used by the user; a storing unit operable to store characteristics information obtained by the obtaining unit; and a calculating unit operable to calculate a score of each piece of characteristics information stored in the storing unit, and output a piece of characteristics information whose score is high, as the preference information.

To fulfill the above object, the preference information managing method of the present invention is a preference information managing method which outputs preference information reflecting a user's preference, comprising: an obtaining step for obtaining one or more pieces of characteristics information corresponding to a packaged content used by the user; a storing step for storing characteristics information obtained by the obtaining step; and a calculating step for calculating a score of each piece of characteristics information stored by the storing step, and output a piece of characteristics information whose score is high, as the preference information.

This allows the preference information managing apparatus to calculate the score of each piece of characteristics information corresponding to packaged contents, which are more highly rated and more preferred by a user than contents from other sources. As a result, users' preference can be digitalized and calculated effectively.

Also, in the above-described preference information managing apparatus, the obtaining unit may obtain (i) an ID, which is recorded in the packaged content, from a packaged content using unit which reads the packaged content, and (ii) characteristics information from an external apparatus based on the obtained ID.

This allows characteristics information to be obtained from an external apparatus, using an ID which is stored in a packaged content. As a result, when characteristics information is not stored in a packaged content just as the case of DVD discs which are currently in widespread use, the present invention can be performed.

Also, in the above-described preference information managing apparatus, the obtaining unit may obtain characteristics information, which is recorded in the packaged content, from a packaged content using unit which reads the packaged content.

This allows characteristics information which is recorded in a packaged content to be obtained. As a result, the present invention can be performed with large-capacity storage media of a new standard, such as Blu-ray discs which are expected to become more popular in the future.

Also, in the above-described preference information managing apparatus, the obtaining unit may obtain a usage type from the packaged content, which indicates whether the packaged content is for purchase or for rental, and the calculating unit calculates the score of each piece of characteristics information in such a manner that in the case where the obtained usage type indicates that the content is for purchase, the score of each piece of characteristics information is multiplied by a larger coefficient than a coefficient for the case where the obtained usage type indicates that the content is for rental.

This allows the preference information managing apparatus to calculate a score of each piece of characteristics information corresponding to packaged contents for purchase by multiplying the score of the each piece of characteristics information by a larger coefficient than a coefficient for characteristics information corresponding to packaged contents for rental. As a result, more accurate preference information can be outputted.

Also, in the above-described preference information managing apparatus, the obtaining unit may obtain one or more pieces of characteristics information corresponding to a non-packaged content used by the user, and the calculating unit may (i) calculate the score of each piece of characteristics information corresponding to the packaged and the non-packaged contents in such a manner that the score of each piece of characteristics information corresponding to the packaged content is multiplied by a larger coefficient than a coefficient for characteristics information corresponding to the non-packaged content, and (ii) output a piece of characteristics information whose score is high, among all pieces of characteristics information corresponding to the packaged and the non-packaged contents, as the preference information.

Also, in the above-described preference information managing method, the obtaining step may obtain one or more pieces of characteristics information corresponding to a non-packaged content used by the user, and the calculating step may(i) calculate the score of each piece of characteristics information corresponding to the packaged and the non-packaged contents in such a manner that the score of each piece of characteristics information corresponding to the packaged content is multiplied by a larger coefficient than a coefficient for characteristics information corresponding to the non-packaged content, and (ii) output a piece of characteristics information whose score is high, among all pieces of characteristics information corresponding to the packaged and the non-packaged contents, as the preference information.

This allows the preference information managing apparatus to calculate a score of each piece of characteristics information corresponding to packaged contents by multiplying a score of the each piece of characteristics information by a larger coefficient than a coefficient for characteristics information corresponding to non-packaged contents.

As a result, more accurate preference information can be outputted.

Also, in the above-described preference information managing apparatus, the storing unit may store characteristics information corresponding to the packaged and the non-packaged contents in a form where whether a source of characteristics information is the packaged content or the non-packaged content is identifiable, and the calculating unit may multiply, when performing the calculation, the score of each piece of characteristics information corresponding to the packaged content by a larger coefficient than a coefficient for characteristics information corresponding to the non-packaged content.

This allows the preference information managing apparatus to store characteristics information corresponding to packaged contents and non-packaged contents in identifiable forms, and to multiply a score of each piece of the characteristics information corresponding to non-packaged contents, when calculating the score of each piece of characteristics information. As a result, coefficient can be changed at the time of calculating, which means there is a lot of flexibility.

Also, in the above-described preference information managing apparatus, the storing unit may store characteristics information corresponding to the packaged and the non-packaged contents after the score of each piece of characteristics information corresponding to the packaged content is multiplied by a larger coefficient than a coefficient for characteristics information corresponding to the non-packaged content.

This allows the score of each piece of characteristics information to be multiplied by coefficient at the time of storage.

As a result, the calculation processing becomes faster.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 shows the configuration of the preference information managing apparatus of the first embodiment of the present invention;

FIG. 2 is an example list of characteristic information which is stored in the storing unit 14;

FIG. 3 is an example EPG, in which only indications of programs whose EPG data include the same information as the preference information are modified by a change in background pattern;

FIG. 4 is an example EPG, in which only indications of programs whose EPG data include the same information as the preference information are modified by putting a particular mark;

FIG. 5 is an example VOD menu, in which guides of programs whose VOD menu data include the same information as the preference information includes are inserted;

FIG. 6 represents the operation procedure of the preference information managing apparatus 1 of the first embodiment of the present invention, for storing a user's usage history of packaged contents and other contents as characteristics information;

FIG. 7 represents the operation procedure of the preference information managing apparatus 1 of the first embodiment of the present invention, for (i) calculating the score of each piece of characteristics information which is stored by the operation procedures of FIG. 6, and (ii) outputting and making use of the result of calculation as preference information;

FIG. 8 shows the configuration of the preference information managing apparatus 5 and the meta data managing server 6 of the second embodiment of the present invention;

FIG. 9 represents the operation procedure of the preference information managing apparatus 5 of the second embodiment of the present invention, for storing a user's usage history of packaged contents and the other contents as characteristics information;

FIG. 10 is the configuration of a modification of the present invention corresponding to the first embodiment, where components for storing characteristics information and components for using preference information are provided by separate apparatuses; and

FIG. 11 is the configuration of a modification of the present invention corresponding to the second embodiment, where components for storing characteristics information and components for using preference information are provided by separates apparatuses.

### DESCRIPTION OF THE PREFERRED EMBODIMENTS

### The First Embodiment

<Configuration>

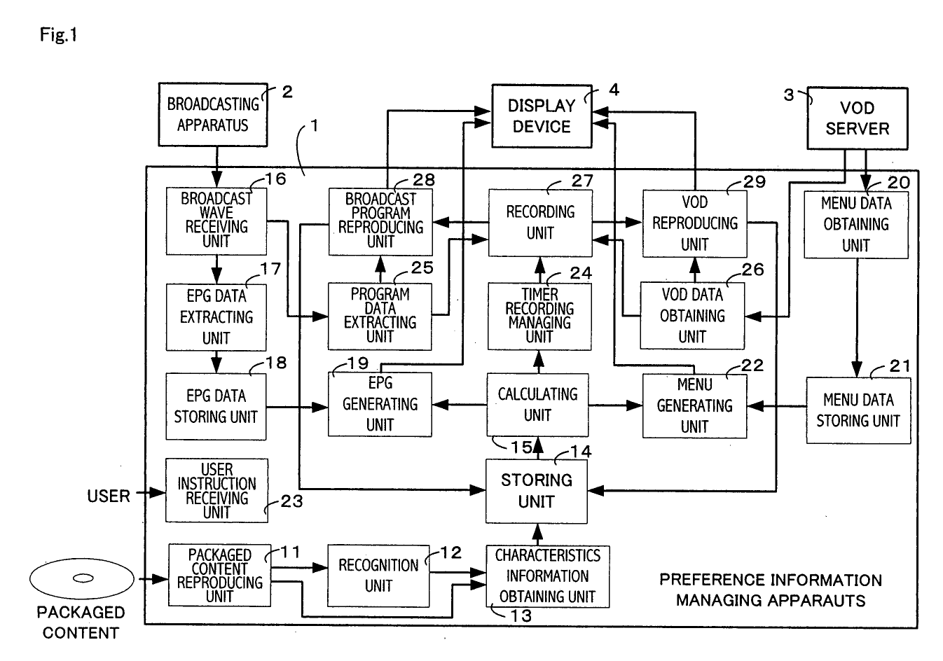

FIG. 1 shows the configuration of a preference information managing apparatus 1 according to the first embodiment of the present invention.

In FIG. 1, a broadcasting apparatus 2, a VOD server 3, and a display device 4 are included for describing the preference information managing apparatus 1.

The broadcasting apparatus 2 is, for instance, a broadcast satellite which broadcasts digital satellite waves, a broadcast station which broadcasts digital ground-based waves, or a broadcasting apparatus which is installed in a cable TV station. The broadcasting apparatus 2 broadcasts broadcast waves multiplexed with EPG data and various data, such as broadcast program contents, using time-division multiplex technology.

Here, “EPG data” means data which includes all the necessary information for generating an EPG (Electric Program Guide), and “broadcast program contents” means video data and audio data included in broadcast programs.

The VOD server 3 is, for instance, a commercial site providing VOD (Video on Demand), and transmits VOD menu data and VOD contents via a network, according to users' requests.

Here, “VOD menu data” means data which includes all the necessary information for generating a VOD menu, and “VOD contents” means video data and audio data for a VOD.

The display device 4 is, for instance, a CRT monitor or a LCD monitor, and displays an EPG which is generated by an EPG generating unit 19 and a VOD menu which is generated by a menu generating unit 22.

As shown in FIG. 1, the preference information managing apparatus 1 of the first embodiment includes a packaged content reproducing unit 11, a recognition unit 12, a characteristics information obtaining unit 13, a storing unit 14, a calculating unit 15, a broadcast wave receiving unit 16, an EPG data extracting unit 17, an EPG data storing unit 18, the EPG generating unit 19, a menu data obtaining unit 20, a menu data storing unit 21, the menu generating unit 22, a user instruction receiving unit 23, a timer recording managing unit 24, a program data extracting unit 25, a VOD data obtaining unit 26, a recording unit 27, a broadcast program reproducing unit 28, and a VOD reproducing unit 29. In FIG. 1, note that lines which represent the relation among the user instruction receiving unit 23 and other components are not shown for simplification.

When a package including a packaged content, such as an optical disc purchased or rented by a user, is placed in position, the packaged content reproducing unit 11 loads the packaged content. Then, the packaged content reproducing unit 11 reads and reproduces digital content recorded in the package according to the user's instruction.

The recognition unit 12 recognizes the packaged content which is ready to be read, by trial reading of a part of content data loaded by the packaged content reproducing unit 11.

The characteristics information obtaining unit 13 obtains, from the package content which is recognized by the recognition unit 12, particular items of metadata which are recorded in the package, as the first characteristics information. The particular items of metadata are previously set as items relating to the user's preference. Also, the characteristics information obtaining unit 13 obtains, from the EPG storing unit 18, particular items of EPG data relating to non-packaged contents which have been reproduced by the broadcast program reproducing unit 28, as the second characteristics information. The particular items of EPG data are previously set as items relating to the user's preference. Also, the characteristics information obtaining unit 13 obtains, from the menu data storing unit 21, particular items of VOD menu data relating to non-packaged contents which have been reproduced by the VOD reproducing unit 29, as the third characteristics information. The particular items of VOD menu data are previously set as items relating to the user's preference.

Note that the packaged contents in the first embodiment include at least a digital content and metadata.

A digital content includes, for instance, music, software games, moving pictures such as a movie, and still pictures.

Metadata is information which represents characteristics and attributes of content, and includes items such as genre, bit rate, compression format, file size, keyword, and whether the content is for purchase or for rental. Especially when the content is music, the metadata includes items, such as album title, artist's name, player's name, song title, play time, lyric writer, composer, release date, jacket picture, lyrics, score, and sample rate. Especially when the content is software games, the metadata includes items, such as game title, manufacturer's name, and characters' data, and when the contents are movies, the metadata includes items such as movie title, performers' name, director's name, staffs' name, country of production, running time, distributor, language, release date, rating (PG-13, etc.), and region.

Particular items of metadata, EPG data, and VOD menu data which are previously set as items relating to the user's preference are, for instance, genre, keyword, whether the content is for purchase or for rental, album title, artist's name, player's name, song title, lyric writer, composer, game title, movie title, performers' name, director's name, and stuffs' name.

The storing unit 14 stores the first characteristics information, the second characteristics information, and the third characteristics information which are obtained by the characteristics information obtaining unit 13. Here, the storing unit 14 stores each piece of characteristics information in a form where whether the source of the characteristics information is packaged contents or not is identifiable, and for instance, the weight for the first characteristics information which is obtained from packaged contents for rental is rated at “2”, the weight for the first characteristics information which is obtained from packaged contents for purchase is rated at “3”, and the weights for the second characteristics information and the third characteristics information which are obtained from other than packaged contents are rated at “1”.

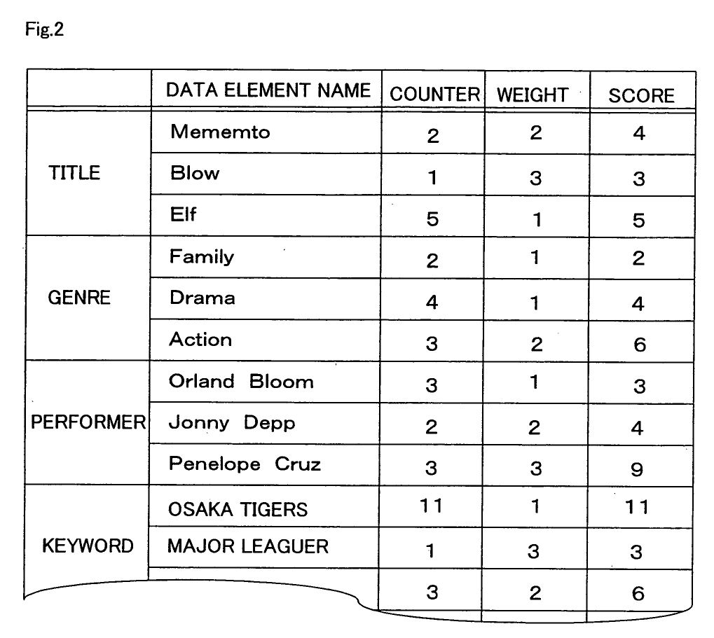

FIG. 2 is an example list of the characteristics information which is stored in the storing unit 14.

As shown in FIG. 2, each piece of characteristics information is classified by item, such as “title”, “genre” and so on, and each piece of characteristics information has a value of “counter”, “weight” and “score” and also has “data element name”. As to a piece of characteristics information of a title item whose data element name is “Mememto”, which is the first characteristics information obtained from a packaged content for rental, the value of the counter, which represents a number of usage, is “2”. This means that the packaged content have been accessed twice. The value of the weight is “2”. This means that the packaged content is for rental. This shows that the value of the score of the piece of characteristics information is “4”. (The counter “2” multiplied by the weight “2” is “4”.) As to a piece of characteristics information of the title item whose data element name is “Blow”, which is the first characteristics information obtained from a packaged content for purchase, the value of the counter is “1”, which means that the packaged content have been accessed once. The value of the weight is “3”, which means that the packaged content is for purchase. This shows that the value of the score of the piece of characteristics information is “3”. (The counter “1” multiplied by the weight “3” is “3”.) As to a piece of characteristics information of the title item whose data element name is “Elf”, which is the third characteristics information obtained from the menu data storing unit 21, the value of the counter is “5”, which means that the piece of characteristics information is obtained from a content which have been accessed five times. The value of the weight is “1”, which means that the content is a non-packaged content. This shows that the value of the score of the piece of characteristics information is “5”. (The counter “5” multiplied by the weight “1” is “5”.) The value of a counter, the value of a weight, and the value of a score of each piece of characteristics information classified into other items, such as genre, performer, and keyword are calculated in the same way as the case of the title item. Therefore, the description is omitted here.

The calculating unit 15 calculates the score of each piece of the stored characteristics information, and outputs, per item, pieces of characteristics information whose scores are the highest as the preference information. Here, the calculating unit 15 calculates a score of each piece of characteristics information corresponding to packaged contents by multiplying a value of a counter of each piece of the characteristics information by a larger coefficient than a coefficient for characteristics information corresponding to non-packaged contents, and outputs pieces of characteristics information whose scores are the highest as the preference information. For instance, the calculating unit 15 calculates a score of each piece of characteristics information which is obtained from packaged contents for rental by multiplying a value of a counter of each piece of the characteristics information by the coefficient for weighting “2”, and calculates a score of each piece of characteristics information which is obtained from packaged contents for purchase by multiplying a value of a counter of each piece of the characteristics information by the coefficient for weighting “3”. A score of each piece of characteristics information which is obtained from other than packaged contents is calculated without multiplication.

The broadcast wave receiving unit 16 receives broadcast waves which are broadcasted by the broadcasting apparatus 2.

The EPG data extracting unit 17 extracts EPG data which is multiplexed with the broadcast wave received by the broadcast wave receiving unit 16.

The EPG data storing unit 18 stores EPG data which are extracted by the EPG data extracting unit 17.

The EPG generating unit 19 generates an EPG by the conventional method, based on the EPG data stored in the EPG data storing unit 18, according to the instructions for displaying an EPG from a user. Also, the EPG generating unit 19 requests the calculating unit 15 to output the preference information and, displays, on the display device 4, the generated EPG with modification based on the preference information which is outputted by the calculating unit 15. More specifically, the EPG generating unit 19 modifies, among EPG data which are generated by the conventional method, indications of programs whose EPG data include the same information as the preference information outputted by the calculating unit 15. For instance, the EPG generating unit 19 changes the text color, the background color, the character style, the background pattern, and the outer frame of the indication of the program, or puts a particular mark on the indication of the program, for emphasis.

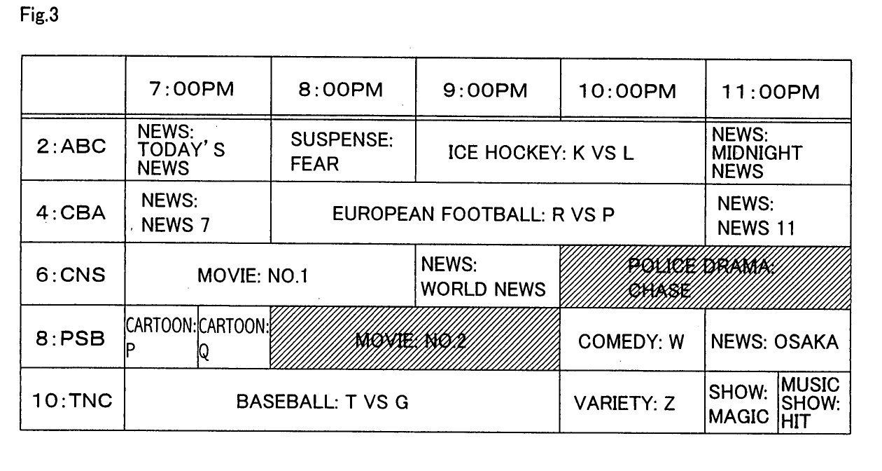

FIG. 3 is an example EPG, in which only indications of programs whose EPG data include the same information as the preference information are modified by the change in background pattern.

As shown in FIG. 3, the background color of “movie: No. 2” which is broadcasted at PM8:00 on channel 8 or PSB and “police drama: Chase” which is broadcasted at PM10:00 on channel 6 or CNS are different and distinguished from the background color of the other indications of programs on the screen.

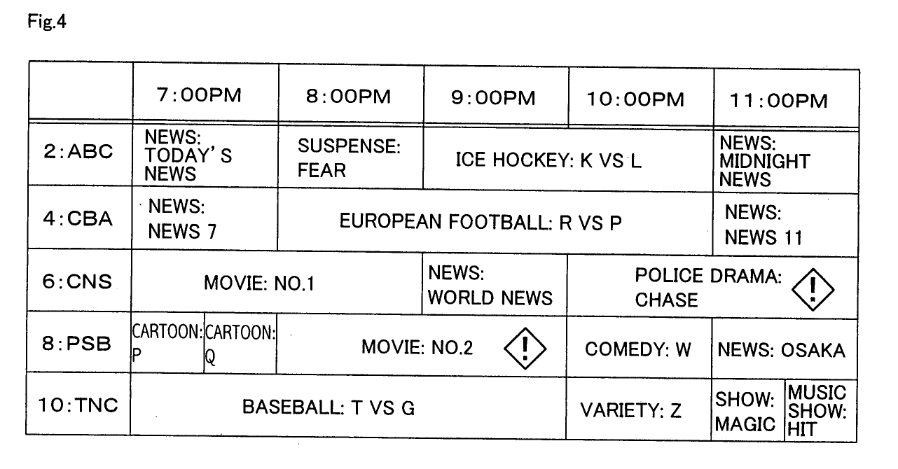

FIG. 4 is an example EPG, in which only indications of programs whose EPG data include the same information as the preference information are modified by putting a particular mark.

As shown in FIG. 4, the particular mark is put on “movie: No. 2” which is broadcasted at PM8:00 on channel 8 or PSB and on “police drama: Chase” which is broadcasted at PM10:00 on channel 6 or CNS, and these indications of a programs are distinguished from the other indications of programs on the screen.

The menu data obtaining unit 20 requests the VOD server 3 to distribute VOD menu data, and receives VOD menu data from the VOD server 3.

The menu data storing unit 21 stores VOD menu data which is received by the menu data obtaining unit 20.

The menu generating unit 22 generates a VOD menu by the conventional method, based on the VOD menu data stored in the VOD menu data storing unit 21, according to the instructions for displaying a VOD menu from a user. Also, the menu generating unit 22 requests the calculating unit 15 to output the preference information, and displays, on the display device 4, the generated VOD menu with modification based on the preference information outputted by the calculating unit 15. More specifically, the VOD generating unit 19 inserts, in a VOD menu which is generated by the conventional method, guides of programs whose VOD menu data include the same information as the preference information outputted by the calculating unit 15, and the guides are distinguished from the other indications on the screen.

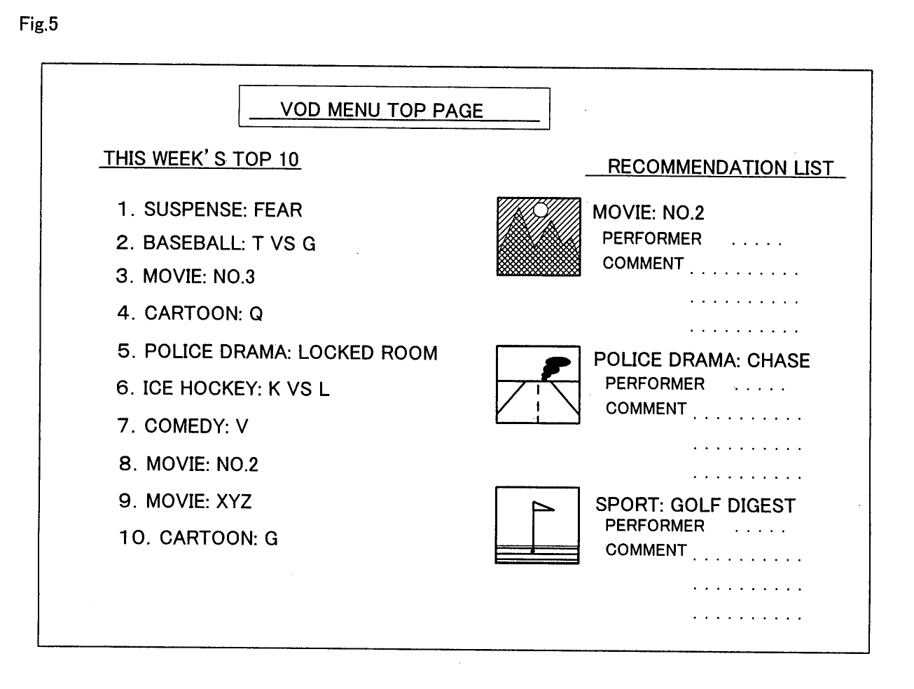

FIG. 5 is an example VOD menu, in which guides of programs whose VOD menu data include the same information as the preference information are inserted.

As shown in FIG. 5, guides of programs “movie: NO. 2”, “police drama: Chase”, and “sport: Golf Digest”, whose VOD menu data include the same information as the preference information, are inserted in the field which is titled “Recommendation List”, and the guides are distinguished from the other indications on the screen.

The user instruction receiving unit 23 receives, from a user, various instructions, such as instructions for reproducing packaged contents, instructions for displaying an EPG, instructions for reproducing broadcast programs, instructions for displaying a VOD menu, instructions for reproducing a VOD, instructions for reproducing recorded broadcast programs, instructions for reproducing recorded VOD data, instructions for recording broadcast programs, and instructions for recording a VOD.

The timer recording managing unit 24 regularly gives the EPG data extracting unit 17 instructions to extract EPG data, regularly gives the menu data obtaining unit 20 instructions to obtain VOD menu data, and regularly gives the calculating unit 15 instructions to output the preference information. The timer recording managing unit 24 searches, from EPG data which are stored in the EPG data storing unit 18, for broadcast programs which include the same EPG data as the preference information outputted by the calculating unit 15. Then, the timer recording managing unit 24 sets the timer for recording the searched programs, and makes broadcast program recording request at the set start time of the recording. The timer recording managing unit 24 also searches, from VOD menu data which are stored in the menu data storing unit 21, for VOD data which include the same VOD menu data as the preference information outputted by the calculating unit 15. Then, the timer recording managing unit 24 makes VOD data recording request.

The program data extracting unit 25 extracts multiplexed program data from broadcast waves which are received by the broadcast wave receiving unit.

The VOD data obtaining unit 26 requests the VOD server 3 to distribute VOD data, and receives VOD data from the VOD server 3.

The recording unit 27 records program data which is extracted by the program data extracting unit 25, according to broadcast program recording requests from the timer recording managing unit 24. The recording unit 27 also records VOD data which is received by the VOD data obtaining unit 26, according to VOD data recording requests from the timer recording managing unit 24.

The broadcast program reproducing unit 28 reproduces and displays, on the display device 4, program data which is extracted by the program data extracting unit 25, according to instructions from a user to reproduce broadcast programs. The broadcast program reproducing unit 28 also reproduces and displays, on the display device 4, programs data which is recorded by the recording unit 27, according to instructions from a user to reproduce recorded broadcast programs.

The VOD reproducing unit 29 reproduces and displays, on the display device 4, VOD data which is received by the VOD data obtaining unit 26, according to instructions from a user to reproduce a VOD. The VOD reproducing unit 29 also reproduces and displays, on the display device 4, VOD data which is recorded by the recording unit 27, according to instructions from a user to reproduce recorded VOD data.

<Operation>

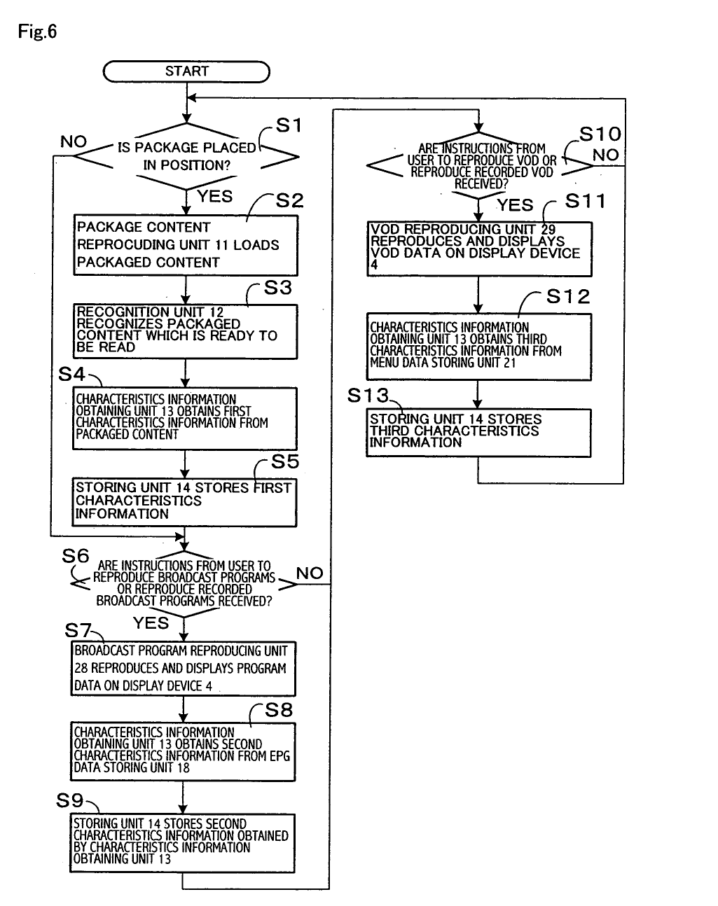

FIG. 6 represents the operation procedure of the preference information managing apparatus 1 of the first embodiment of the present invention, for storing a user's usage history of packaged contents and other contents as characteristics information.

The operation procedure for storing a user's usage history of packaged contents and other contents as characteristics information is described below with reference to FIG. 6.

(1f) The packaged content reproducing unit 11 waits for a package including a packaged content to be placed in position by a user (step S1).

(2) The packaged content reproducing unit 11 loads the packaged content included in the package which is placed in position (step S2).

(3) The recognition unit 12 recognizes the packaged content which is ready to be read (step S3).

(4) The characteristics information obtaining unit 13 obtains the first characteristics information from the packaged content recognized by the recognition unit 12 (step S4).

(5) The storing unit 14 stores the first characteristics information which is obtained by the characteristics information obtaining unit 13 (step S5). Here, when the obtained first characteristics information includes a usage type which indicates that the content is for rental, the storing unit 14 rates a weight of each piece of the first characteristics information at “2”, and when the obtained first characteristics information includes a usage type which indicates that the content is for purchase, the storing unit 14 rates the weight of each piece of the first characteristics information at “3”.

(6) The user instruction receiving unit 23 waits for instructions from a user to reproduce broadcast programs or reproduce recorded broadcast programs (step S6).

(7) The broadcast program reproducing unit 28 reproduces and displays, on the display device 4, program data which is extracted by the program data extracting unit 25 or program data which is recorded by the recording unit 27, according to the instructions from a user (step S7).

(8) The characteristics information obtaining unit 13 obtains the second characteristics information from the EPG data storing unit 18 (step S8).

(9) The storing unit 14 stores the second characteristics information which is obtained by the characteristics information obtaining unit 13 (step S9). Here, the storing unit 14 rates a weight of each piece of the second characteristics information at “1”.

(10) The user instruction receiving unit 23 waits for instructions from a user to reproduce VOD or reproduce recorded VOD (step S10).

(11) The VOD reproducing unit 29 reproduces and displays, on the display device 4, VOD data which is received by the VOD data obtaining unit 26, or VOD data which is recorded by the recording unit 27, according to the instructions from a user (step S11).

(12) The characteristics information obtaining unit 13 obtains the third characteristics information from the menu data storing unit 21 (step S12).

(13) The storing unit 14 stores the third characteristics information which is obtained by the characteristics information obtaining unit 13 (step S13). Here the storing unit 14 rates a weight of each piece of the third characteristics information at “1”.

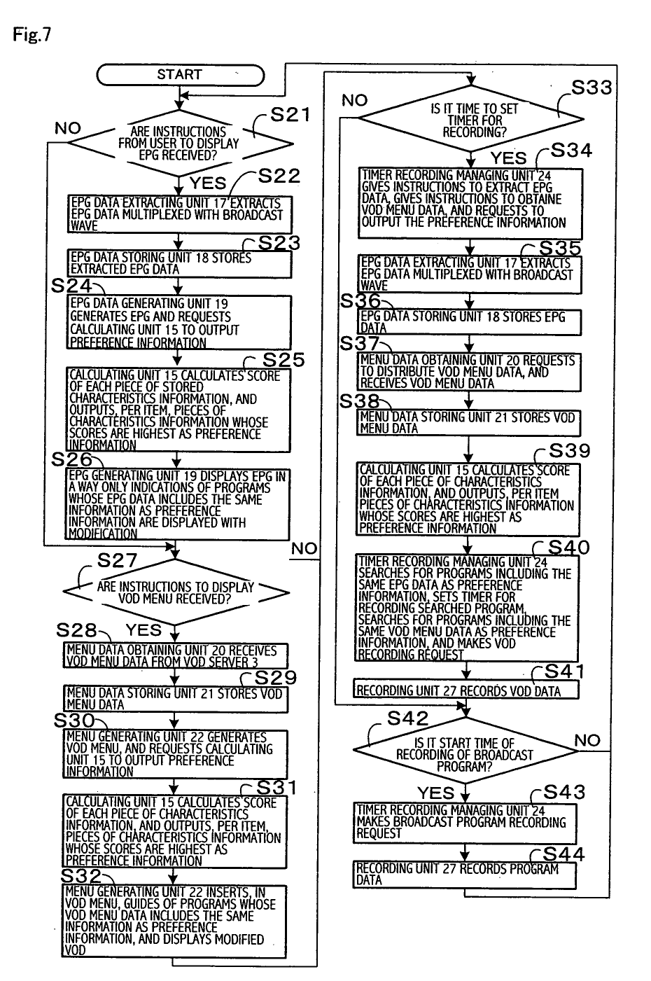

FIG. 7 represents the operation procedure of the preference information managing apparatus 1 of the first embodiment of the present invention, for calculating a score of each piece of characteristics information which is stored by the operation procedure of FIG. 6, and outputting and making use of the result of calculation as preference information.

The followings are the description of the operation procedure for calculating a score of each piece of characteristics information and outputting the result of calculation as preference information, with reference to FIG. 7.

(1) The user instruction receiving unit 23 waits for instructions from a user to display an EPG (step S21).

(2) The EPG data extracting unit 17 extracts EPG data which is multiplexed with the broadcast wave which is received by the broadcast wave receiving unit 16 (step S22).

(3) The EPG data storing unit 18 stores the EPG data which is extracted by the EPG data extracting unit 17 (step S23).

(4) The EPG data generating unit 19 generates an EPG by the conventional method, based on the EPG data stored in the EPG data storing unit 18, and requests the calculating unit 15 to output the preference information (step S24).

(5) The calculating unit 15 calculates a score of each piece of the stored characteristics information, and outputs, per item, pieces of characteristics information whose scores are the highest as the preference information (step S25). Here, the calculating unit 15 calculates a score of each piece of characteristics information obtained from packaged contents for rental, by multiplying a value of a counter of the each piece of characteristics information by a coefficient for weighting “2”, and calculates a score of each piece of characteristics information obtained from packaged contents for purchase, by multiplying a value of a counter of each piece of the characteristics information by a coefficient for weighting “3”.

(6) The EPG generating unit 19 displays, on the display device 4, the generated EPG. Only indications of programs whose EPG data include the same information as the preference information are displayed with modification. For instance, the EPG generating unit 19 changes the text color, the background color, the character style, the background pattern, and the outer frame of the indication of the program, or puts a particular mark on the indication of the program, for emphasis (step S26).

(7) The user instruction receiving unit 23 waits for instructions from a user for displaying a VOD menu (step S27).

(8) The menu data obtaining unit 20 requests the VOD server 3 to distribute VOD menu data, and receives VOD menu data from the VOD server 3 (step S28).

(9) The menu data storing unit 21 stores the VOD menu data which is received by the menu data obtaining unit 20 (step S29).

(10) The menu generating unit 22 generates a VOD menu by the conventional method, based on the VOD menu data stored in the VOD menu data storing unit 21, according to the instructions from a user for displaying a VOD menu. Also, the menu generating unit 22 requests the calculating unit 15 to output the preference information (step S30).

(11) The calculating unit 15 calculates the score of each piece of the stored characteristics information, and outputs, per item, pieces of characteristics information whose scores are the highest as the preference information (step S31). Here, the calculating unit 15 calculates a score of piece of characteristics information obtained from packaged contents for rental by multiplying a value of a counter of each piece of characteristics information by a coefficient for weighting “2”, and calculates a score of each piece of characteristics information obtained from packaged contents for purchase by multiplying a value of a counter of each piece of characteristics information by a coefficient for weighting “3”.

(12) The menu generating unit 22 inserts, in a VOD menu, guides of programs whose VOD menu data include the same information as the preference information outputted by the calculating unit 15, then displays the modified VOD menu on the display device 4 (step S32).

(13) The timer recording managing unit 24 waits for the time to set the timer for recording (step S33).

(14) The timer recording managing unit 24 gives the EPG data extracting unit 17 instructions to extract EPG data, gives the menu data obtaining unit 20 instructions to obtain VOD menu data, and requests the calculating unit 15 to output the preference information (step S34).

(15) The EPG data extracting unit 17 extracts the EPG data which is multiplexed with the broadcast wave which is received by the broadcast wave receiving unit 16 (step S35).

(16) The EPG data storing unit 18 stores the EPG data which is extracted by the EPG data extracting unit 17 (step S36).

(17) The menu data obtaining unit 20 requests the VOD server 3 to distribute VOD menu data, and receives VOD menu data from the VOD server 3 (step S37).

(18) The menu data storing unit 21 stores the VOD menu data which is received by the menu data obtaining unit 20 (step S38).

(19) The calculating unit 15 calculates a score of each piece of the stored characteristics information, and outputs, per item, pieces of characteristics information whose scores are the highest as the preference information (step S39). Here, the calculating unit 15 calculates a score of each piece of characteristics information obtained from packaged contents for rental by multiplying a value of a counter of each piece of characteristics information by a coefficient for weighting “2”, and calculates a score of each piece of characteristics information obtained from packaged contents for purchase by multiplying a value of a counter of the each piece of characteristics information by a coefficient for weighting “3”.

(20) The timer recording managing unit 24 searches, from EPG data which is stored in the EPG data storing unit 18, for programs which include the same EPG data as the preference information outputted by the calculating unit 15. Then, the timer recording managing unit 24 sets the timer for recording the searched programs. Also, the timer recording managing unit 24 searches, from VOD menu data which is stored in the menu data storing unit 21, for programs which include the same VOD menu data as the preference information outputted by the calculating unit 15. Then, the timer recording managing unit 24 makes VOD recording request to record the searched programs (step S40).

(21) The recording unit 27 records the VOD data which is received by the VOD data obtaining unit 26, according to the VOD recording request from the timer recording managing unit 24 (step S41).

(22) The timer recording managing unit 24 waits for the start time of the recording of the broadcast program (step S42).

(23) The timer recording managing unit 24 makes broadcast program recording request (step S43).

(24) The recording unit 27 records the program data which is extracted by the program data extracting unit 25, according to the broadcast program recording request from the timer recording managing unit 24 (step S44).

### The Second Embodiment

<Configuration>

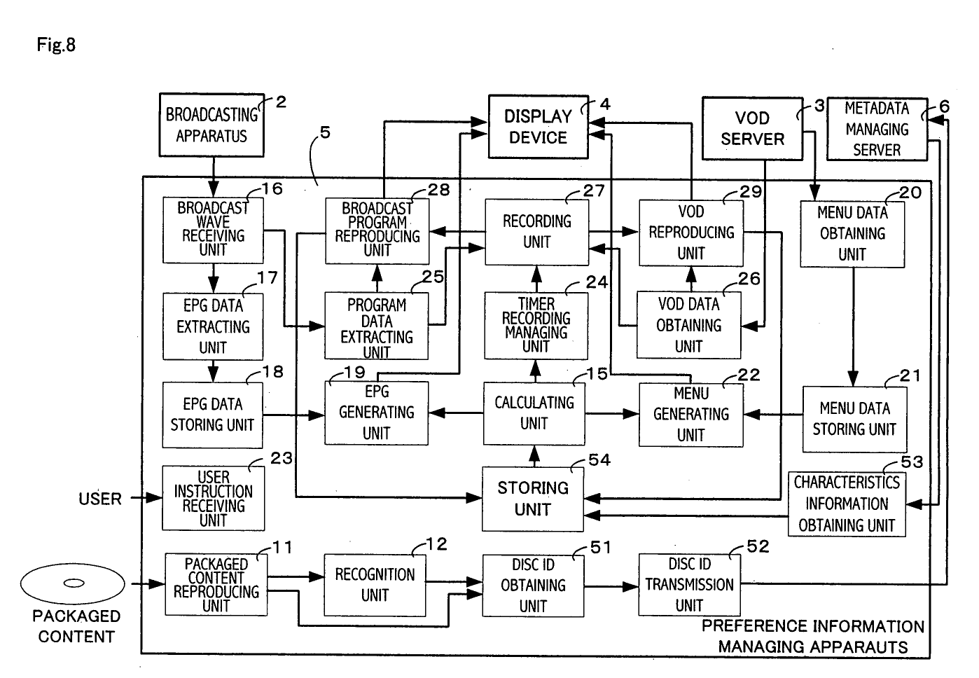

FIG. 8 shows the configuration of a preference information managing apparatus 5 and a metadata managing server 6 of the second embodiment of the present invention.

Here, the peripheral devices and the components in the second embodiment which have same function as those of the first embodiment are numbered correspondingly, and the description is omitted.

The broadcasting apparatus 2, the VOD server 3, and the display device 4 is included in FIG. 8, for explaining the preference information managing apparatus 5 and the metadata managing server 6.

The metadata managing server 6 stores and manages metadata by relating the metadata to disc IDs. When a given disc ID is transmitted from the preference information managing apparatus 5, the metadata managing server 6 retransmits metadata relating to the given disc ID, which is stored in the metadata managing server 6.

As shown in FIG. 8, the preference information managing unit 5 of the second embodiment includes the packaged content reproducing unit 11, the recognition unit 12, a disc ID obtaining unit 51, a disc ID transmission unit 52, a characteristics information obtaining unit 53, a storing unit 54, the calculating unit 15, the broadcast wave receiving unit 16, the EPG data extracting unit 17, the EPG data storing unit 18, the EPG generating unit 19, the menu data obtaining unit 20, the menu data storing unit 21, the menu generating unit 22, the user instruction receiving unit 23, the timer recording managing unit 24, the program data extracting unit 25, the VOD data obtaining unit 26, the recording unit 27, the broadcast program reproducing unit 28, and the VOD reproducing unit 29. Note that in FIG. 8, lines which represent the relation among the user instruction receiving unit 23 and other components are not shown for simplification.

The disc ID obtaining unit 51 obtains, from a packaged content which is recognized by the recognition unit 12, a disc ID which is stored in the packaged content.

Note that the packaged contents in the second embodiment include, at least, a digital content and a disc ID.

The disc id transmission unit 52 transmits the disc ID which is obtained by the disc ID obtaining unit 51 to the metadata managing server 6.

The characteristics information obtaining unit 53 receives, from the metadata managing server 6, metadata which is corresponding to the disc ID which is transmitted by the disc ID transmission unit 52, and the characteristics information obtaining unit 53 obtains particular items of the received metadata as the first characteristics information. The particular items of the received metadata are previously set as items relating to the user's preference. Also, the characteristics information obtaining unit 53 obtains, from the EPG storing unit 18, particular items of EPG data relating to non-packaged contents which have been reproduced by the broadcast program reproducing unit 28, as the second characteristics information. The particular items of EPG data are previously set as items relating to the user's preference. Also, the characteristics information obtaining unit 53 obtains, from the menu data storing unit 21, particular items of VOD menu data relating to non-packaged contents which have been reproduced by the VOD reproducing unit 29, as the third characteristics information. The particular items of VOD menu data are previously set as items relating to the user's preference.

The storing unit 54 stores the first characteristics information, the second characteristics information, and the third characteristics information, which are obtained by the characteristics information obtaining unit 53. Here, the storing unit 54 stores each piece of characteristics information in a form where whether the source of the characteristics information is packaged contents or not is identifiable. For instance, a weight of each piece of the first characteristics information which is obtained from packaged contents for rental is rated at “2”, and a weight of each piece of the first characteristics information which is obtained from packaged contents for purchase is rated at “3”, and a weight of each piece of the second characteristics information and the third characteristics information which are obtained from other than packaged contents is rated at “1”.

The list of the characteristics information which is stored in the storing unit 54 is the same as that of the first embodiment, and therefore the description is omitted here.

<Operation>

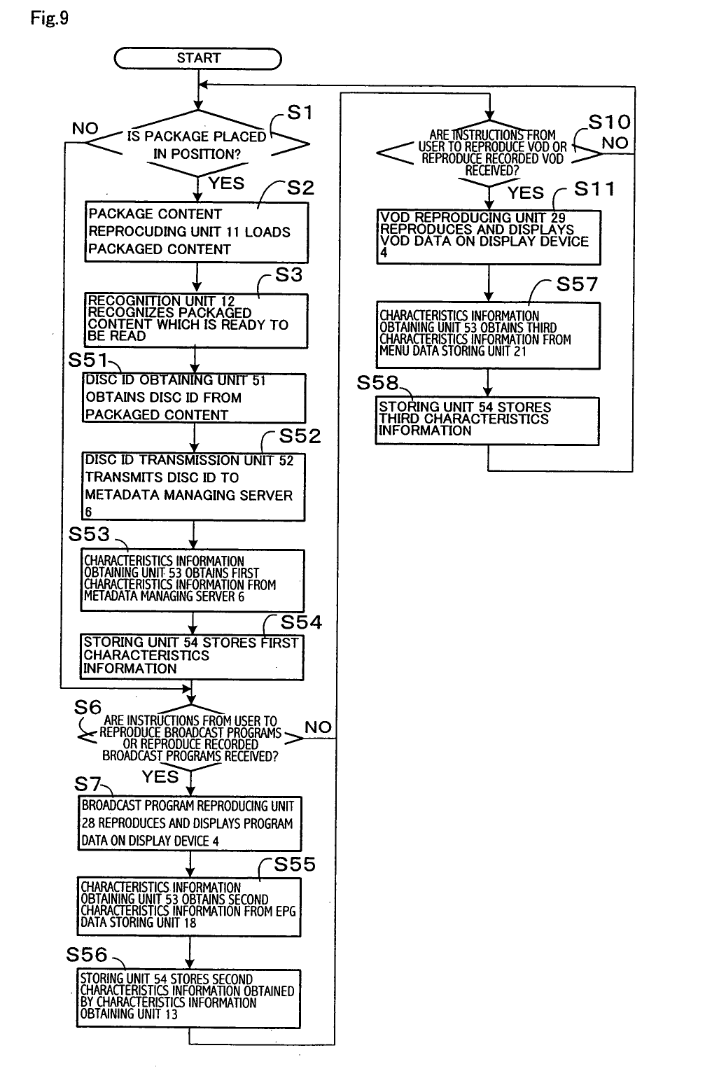

FIG. 9 represents the operation procedure of the preference information managing apparatus 5 of the second embodiment of the present invention, for storing a user's usage history of packaged contents and other contents as characteristics information.

The operation procedure for storing, as characteristics information, a user's usage history of packaged contents and other contents, is described below with reference to FIG. 9.

The steps which have same function as the steps in FIG. 6 of the first embodiment are numbered correspondingly, and the description is omitted.

(1)˜(3) Same as (1)˜(3) in FIG. 6 (step S1˜S3).

(4) The disc ID obtaining unit 51 obtains, from the packaged content which is recognized by the recognition unit 12, the disc id which is stored in the recognized packaged content (step S51).

(5) The disc ID transmission unit 52 transmits the disc ID which is obtained by the disc ID obtaining unit 51 to the metadata managing server 6 (step S52).

(6) The characteristics information obtaining unit 53 receives, from the metadata managing server 6, the metadata which is related to the disc ID which is transmitted by the disc ID transmission unit 52. Then, the characteristics information obtaining unit 53 obtains the first characteristics information which is included in the received metadata (step S53).

(7) The storing unit 54 stores the first characteristics information which is obtained by the characteristics information obtaining unit 53 (step S54). Here, when the obtained first characteristics information includes a usage type which indicates that the content is for rental, the storing unit 54 rates a weight of each piece of the first characteristics information at “2”, and when the obtained first characteristics information includes a usage type which indicates that the content is for purchase, the storing unit 54 rates a weight of each piece of the first characteristics information at “3”.

(8)˜(9) Same as (6)˜(7)in FIG. 6 (step. S6˜S7).

(10) The characteristics information obtaining unit 53 obtains the second characteristics information from the EPG data storing unit 18 (step S55).

(11) The storing unit 54 stores the second characteristics information which is obtained by the characteristics information obtaining unit 53 (step S56). Here, the storing unit 54 rates a weight of each piece of the second characteristics information at “1”.

(12)˜(13) Same as (10)˜(11) in FIG. 6 (step S10˜S11).

(14) The characteristics information obtaining unit 53 obtains the third characteristics information from the menu data storing unit 21 (step S57).

(15) The storing unit 54 stores the third characteristics information which is obtained by the characteristics information obtaining unit 53 (step S58). Here the storing unit 54 rates a weight of each piece of the third characteristics information at “1”.

The operation procedure for (i) calculating a score of each piece of characteristics information which is stored by the operation procedure described in FIG. 9, and (ii) outputting and making use of the result of calculation as the preference information, is same as the corresponding operation procedure of the first embodiment. Therefore, the description is omitted here.

<Summary>

As described above, with the first and second embodiments of the present invention, users' preference is effectively digitalized and calculated by calculating a score of each piece of characteristics information relating to packaged contents. Also, by calculating a score of each piece of characteristics information relating to packaged contents by multiplying a value of a counter of the each piece of characteristics information by a larger coefficient than a coefficient for characteristics information corresponding to non-packaged contents, more accurate preference information than that of conventional arts can be outputted. Furthermore, by calculating a score of each piece of characteristics information corresponding to packaged contents for purchase by multiplying a value of a counter of the each piece of characteristics information by a larger coefficient than a coefficient for characteristics information corresponding to packaged contents for rental, more accurate preference information than that of conventional arts can be outputted.

Note that, in the first and the second embodiments of the present invention, a value of each counter is stored as a score after multiplied by a coefficient for weighting, however, a value of each counter may be stored in an identifiable form before multiplication, and when the calculating unit 15 calculates the score, the value of the each counter may be multiplied by the coefficient for weighting to calculate the score.

Also note that, in the first and the second embodiments of the present invention, when a package including packaged content is placed in position and the packaged content becomes ready to be read, it is recognized that the packaged content is accessed, and then the characteristics information is stored, however, the timing of the recognition is not limited to this. For instance, when a packaged content is actually watched, it may be recognized that the packaged content is accessed, and characteristics information may be stored.

Also note that, in the first and the second embodiments of the present invention, when non-packaged content is reproduced, it is recognized that the non-packaged content is accessed, however, the timing of the recognition is not limited to this. For instance, when a non-packaged content is recorded, it may be recognized that the non-packaged content is accessed, and characteristics information may be stored.

Also note that, in the first and the second embodiments of the present invention, the described apparatus includes all the components for storing characteristics information and all the plural components for using the preference information, however, the apparatus does not necessarily include all the components. The apparatus may include those components only partly.

(The First Modification)

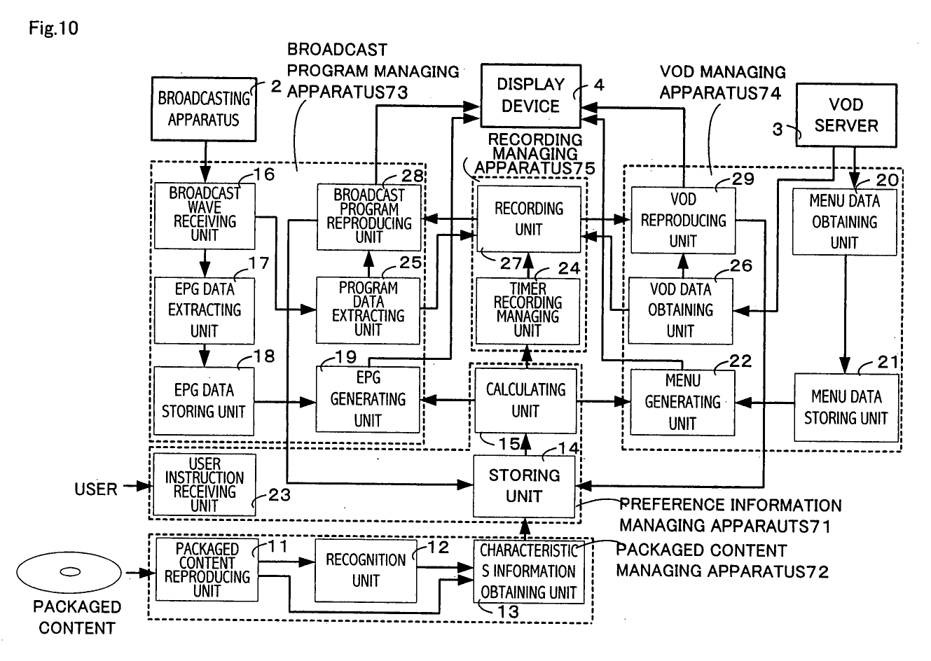

FIG. 10 is a modification of the configuration of the present invention corresponding to the first embodiment, where components for storing characteristics information and components for using preference information are provided by separate apparatuses.

As shown in FIG. 10, a preference information managing apparatus 71 of the first modification includes the storing unit 14, the calculating unit 15, and the user instruction receiving unit 23. A packaged content managing apparatus 72 of the first modification includes the packaged content reproducing unit 11, the recognition unit 12, and the characteristics information obtaining unit 13. A broadcast program managing apparatus 73 of the first modification includes the broadcast wave receiving unit 16, the EPG data extracting unit 17, the EPG data storing unit 18, the EPG generating unit 19, the program data extracting unit 25, and the broadcast program reproducing unit 28. A VOD managing apparatus 74 of the first modification includes the menu data obtaining unit 20, the menu data storing unit 21, the menu data generating unit 22, the VOD data obtaining unit 26, and the VOD reproducing unit 29. A recording managing apparatus 75 of the first modification includes the timer recording managing unit 24, and the recording unit 27.

Here, the peripheral devices and the components which have same function as those of the first embodiment are numbered correspondingly, and the description is omitted.

The configuration of the present invention may be a combination of some of apparatuses which are shown in the first modification. For example, the configuration of the present invention may be a combination of the preference information managing apparatus 71 and the packaged content managing apparatus 72, a combination of the preference information managing apparatus 71 and the broadcast program managing apparatus 73, a combination of the preference information managing apparatus 71 and the VOD managing apparatus 74, a combination of the preference information managing apparatus 71 and the recording managing apparatus 75, a combination of the preference information managing apparatus 71 and the packaged content managing apparatus 72 and the broadcast program managing apparatus 73, a combination of the preference information managing apparatus 71 and the packaged content managing unit 72 and the VOD managing unit 74, a combination of the preference information managing apparatus 71 and the packaged content managing apparatus 72 and the recording managing apparatus 75.

(The Second Modification)

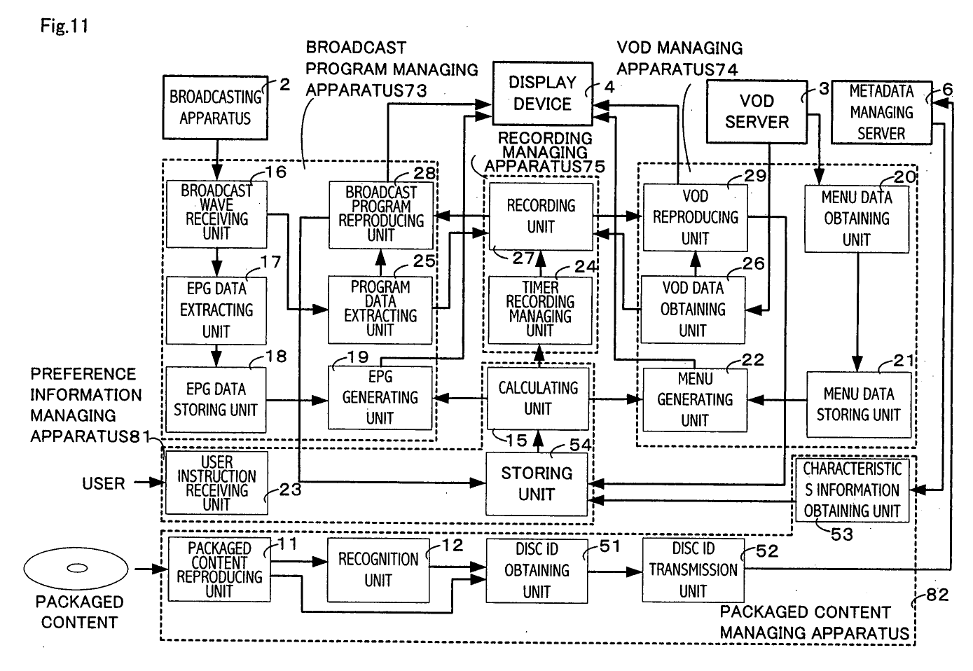

FIG. 11 is the configuration of a modification of the present invention corresponding to the second embodiment, where components for storing characteristics information and components for using preference information are provided by separate apparatuses.

As shown in FIG. 11, a preference information managing apparatus 81 of the second modification includes the storing unit 54, calculating unit 15, and the user instruction receiving unit 23. A packaged content managing apparatus 82 of the second modification includes the packaged content reproducing unit 11, the recognition unit 12, the disc ID obtaining unit 51, the disc ID transmission unit 52, and the characteristics information obtaining unit 53. A broadcast program managing apparatus 73 of the second modification includes the broadcast wave receiving unit 16, the EPG data extracting unit 17, the EPG data storing unit 18, the EPG data generating unit 19, the broadcast program extracting unit 25, and the broadcast program reproducing unit 28. A VOD managing apparatus 74 of the second modification includes the menu data obtaining unit 20, the menu data storing unit 21, the menu data generating unit 22, the VOD data obtaining unit 26, and the VOD reproducing unit 29. A recording managing apparatus 75 of the second modification includes the timer recording managing unit 24, and the recording unit 27.

Here, the peripheral devices and the components which have same function as those of the second embodiment and the first modification are numbered correspondingly, and the description is omitted.

The configuration of the present invention may be a combination of some of apparatuses which are shown in the second modification. For example, the configuration of the present invention may be a combination of the preference information managing apparatus 81 and the packaged content managing apparatus 82, a combination of the preference information managing apparatus 81 and the broadcast program managing apparatus 73, a combination of the preference information managing apparatus 81 and the VOD managing apparatus 74, a combination of the preference information managing apparatus 81 and the recording managing apparatus 75, a combination of the preference information managing apparatus 81 and the packaged content managing apparatus 82 and the broadcast program managing apparatus 73, a combination of the preference information managing apparatus 81 and the packaged content managing unit 82 and the VOD managing unit 74, or a combination of the preference information managing apparatus 81 and the packaged content managing apparatus 82 and the recording managing apparatus 75.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

### INDUSTRIAL APPLICABILITY

The present invention is applicable in automatic recording apparatuses and home servers. The present invention realize automatic timer recording which is based on more accurate preference information than ever, and highlighting of Electric Program Guide. Therefore, the industrial value of the present invention is extremely high. Other than automatic recording apparatuses and home servers, the present invention is applicable in all types of audio-video equipments.

1. A preference information managing apparatus which outputs preference information reflecting a user's preference, comprising:
an obtaining unit operable to obtain one or more pieces of characteristics information corresponding to a packaged content used by the user;
a storing unit operable to store characteristics information obtained by the obtaining unit; and
a calculating unit operable to calculate a score of each piece of characteristics information stored in the storing unit, and output a piece of characteristics information whose score is high, as the preference information.

2. The preference information managing apparatus of claim 1, wherein
the obtaining unit obtains (i) an ID, which is recorded in the packaged content, from a packaged content using unit which reads the packaged content, and (ii) characteristics information from an external apparatus based on the obtained ID.

3. The preference information managing apparatus of claim 1, wherein
the obtaining unit obtains characteristics information, which is recorded in the packaged content, from a packaged content using unit which reads the packaged content.

4. The preference information managing apparatus of claim 1, wherein
the obtaining unit obtains a usage type from the packaged content, which indicates whether the packaged content is for purchase or for rental, and
the calculating unit calculates the score of each piece of characteristics information in such a manner that in the case where the obtained usage type indicates that the content is for purchase, the score of each piece of characteristics information is multiplied by a larger coefficient than a coefficient for the case where the obtained usage type indicates that the content is for rental.

5. The preference information managing apparatus of claim 1, wherein
the obtaining unit further obtains one or more pieces of characteristics information corresponding to a non-packaged content used by the user, and
the calculating unit (i) calculates the score of each piece of characteristics information corresponding to the packaged and the non-packaged contents in such a manner that the score of each piece of characteristics information corresponding to the packaged content is multiplied by a larger coefficient than a coefficient for characteristics information corresponding to the non-packaged content, and (ii) outputs a piece of characteristics information whose score is high, among all pieces of characteristics information corresponding to the packaged and the non-packaged contents, as the preference information.

6. The preference information managing apparatus of claim 5, wherein
the storing unit stores characteristics information corresponding to the packaged and the non-packaged contents in a form where whether a source of characteristics information is the packaged content or the non-packaged content is identifiable, and
the calculating unit multiplies, when performing the calculation, the score of each piece of characteristics information corresponding to the packaged content by a larger coefficient than a coefficient for characteristics information corresponding to the non-packaged content.

7. The preference information managing apparatus of claim 5, wherein
the storing unit stores characteristics information corresponding to the packaged and the non-packaged contents after the score of each piece of characteristics information corresponding to the packaged content is multiplied by a larger coefficient than a coefficient for characteristics information corresponding to the non-packaged content.

8. The preference information managing apparatus of claim 5, wherein
the obtaining unit obtains a usage type from the packaged content, which indicates whether the packaged content is for purchase or for rental, and
the calculating unit calculates the score of each piece of characteristics information in such a manner that in the case where the obtained usage type indicates that the content is for purchase, the score of each piece of characteristics information is multiplied by a larger coefficient than a coefficient for the case where the obtained usage type indicates that the content is for rental.

9. A preference information managing method which outputs preference information reflecting a user's preference, comprising:
an obtaining step for obtaining one or more pieces of characteristics information corresponding to a packaged content used by the user;
a storing step for storing characteristics information obtained by the obtaining step; and
a calculating step for calculating a score of each piece of characteristics information stored by the storing step, and output a piece of characteristics information whose score is high, as the preference information.

10. The preference information managing method of claim 9, wherein
the obtaining step further obtains one or more pieces of characteristics information corresponding to a non-packaged content used by the user, and
the calculating step (i) calculates the score of each piece of characteristics information corresponding to the packaged and the non-packaged contents in such a manner that the score of each piece of characteristics information corresponding to the packaged content is multiplied by a larger coefficient than a coefficient for characteristics information corresponding to the non-packaged content, and (ii) outputs a piece of characteristics information whose score is high, among all pieces of characteristics information corresponding to the packaged and the non-packaged contents, as the preference information.
